(19) United States
(12) Patent Application Publication
(10) Pub. No.: US 2002/0007544 A1
(43) Pub. Date: Jan. 24, 2002

(54) POSITIONING METHOD FOR REGISTRATION PORTION OF MOLDED ITEM AND POSITIONING APPARATUS, SHAPING METHOD FOR MOLDED ITEM AND SHAPING APPARATUS, AND INSTALLING METHOD FOR PARTS

(76) Inventors: HIROMITSU HARADA, USHIKU-SHI (JP); TEIJI OHSAKA, USHIKU-SHI (JP)

Correspondence Address: FITZPATRICK CELLA HARPER & SCINTO, 30 ROCKEFELLER PLAZA, NEW YORK, NY, 10112, US

(21) Appl. No.: 09/321,716

(22) Filed: May 28, 1999

(30) Foreign Application Priority Data
Jun. 1, 1998 (JP) 10-151665
Sep. 21, 1998 (JP) 10-266896
May 18, 1999 (JP) 11-137296

(51) Int. Cl. B23Q 17/00; B23P 19/00

(52) U.S. Cl. 29/407.1; 29/407.01; 29/821

(57) ABSTRACT

A positioning method for a registration portion of an molded item capable of improving the accuracy of a product using the molded item at low cost. The positioning method for a registration portion of the molded item for positioning registration portions W2a, W3a and W4a of the molded item in order to improve the positioning accuracy of the molded item to another member, wherein the registration portions W2a, W3a and W4a are heat-deformed by ultrasonic vibration to thereby position the registration portions.

### BACKGROUND OF THE INVENTION

In order to improve positioning accuracy for a molded item with respect to another member, the present invention relates to a positioning method for a butted-against portion in the molded item and a positioning apparatus for positioning the butted-against portion in the molded item.

Also, the present invention relates to a shaping method and a shaping apparatus for a molded item for shaping, by heat-deforming a shaping area of the molded item by ultrasonic vibration, the shaping area by a target amount of deformation.

Conventionally, in case of a product consisting of parts worked by molding, there is a limit in accumulation of accuracy of single parts to obtain predetermined accuracy by combining a plurality of parts, and therefore, machining such as cutting has been performed by measuring after a plurality of parts are installed. In such a method, however, there have been problems that it is necessary to take into consideration deformation during machining, and to take measures against mixture of chips with the product among others, and further, it might have been very difficult depending upon the product to machine because of problems in terms of shape or rigidity.

In order to solve this problem, it was necessary to eliminate the machining and to select adjusting members such as shims for installing, or to newly provide an adjusting mechanism.

Also, in case of a product which is predicated on replacement of consumables or the like, it was necessary to take into consideration deformation due to a load applied to the product body during replacement, and it was necessary to develop further highly-developed and complicated equipment taking the margin into account or to add new parts capable of being adjusted while the load is being applied by providing new mechanism parts.

With such conventional technique as described above, however, as regards a product which has increasingly advanced and for which higher accuracy has been requested, an increase in the number of parts, an increase in complexity and an increase in cost of the production equipment have been inevitable, and they have caused significant troubles to reduction in cost of the product.

### SUMMARY OF THE INVENTION

The present invention has been achieved in the light of the above-described problems, and is aimed to provide a positioning method for a registration portion in a molded item with low cost, capable of improving the accuracy of a product using the molded item, and a positioning apparatus.

It is another object according to the present invention to provide a shaping method and a shaping apparatus for a molded item capable of shaping with higher accuracy by taking into consideration a degree of deformation of the molded item after the stoppage of ultrasonic vibration.

It is a further another object according to the present invention to provide a registration method for parts capable of registering them accurately.

In order to solve the above-described problems and to attain the object, a positioning method for a registration portion in a molded item according to the present invention is characterized by the following configuration.

That is, in order to improve the positioning accuracy of a molded item with respect to another member, a positioning method for a registration portion in the molded item for positioning the registration portion of the molded item, wherein the registration portion is heat-deformed by ultrasonic vibration to thereby position the registration portion.

A positioning apparatus for a registration portion in a molded item according to the present invention is a positioning apparatus for a registration portion in the molded item for positioning the registration portion of the molded item in order to improve the positioning accuracy of the molded item with respect to another member, comprising: a ultrasonic vibrator which abuts upon the registration portion to cause it to generate heat by the ultrasonic vibration; and biasing means for biasing the registration portion against the ultrasonic vibrator.

A shaping method for a molded item according to the present invention is characterized by the following configuration.

That is, the shaping method for a molded item for heat-deforming the shaping area of a molded item by ultrasonic vibration to shape the shaping area only by a target amount of deformation, wherein an amount of deformation in the shaping area after the stoppage of vibration is predicted on the basis of a deformation velocity of the shaping area during vibration, and when an amount of deformation obtained by adding the predicted amount of deformation after the stoppage of vibration to an amount of deformation in the shaping area up to the present moment, reaches the target amount of deformation, the vibration of the shaping area is terminated.

A shaping apparatus for a molded item according to the present invention is characterized by the following configuration.

That is, the shaping apparatus for a molded item for heat-deforming the shaping area of a molded item by ultrasonic vibration to shape the shaping area only by a target amount of deformation, comprising: predicting means for predicting an amount of deformation in the shaping area after the stoppage of vibration thereof on the basis of the deformation velocity of the shaping area during vibration; and control means for terminating the vibration of the shaping area when an amount of deformation obtained by adding the predicted amount of deformation after the stoppage of vibration to an amount of deformation in the shaping area up to the present moment, reaches the target amount of deformation.

An installing method for parts according to a first aspect of the present invention is characterized by the following configuration.

That is, an installing method for a part for installing a second part to a first part, wherein the first part is provided with a positioning portion for registering with a registration portion of the second part, the second part is provided with a protruded portion for registering with a positioning portion of the first part, and the protruded portion is worked by ultrasonic heating for registering the first part with the second part.

An installing method for parts according to a second aspect of the present invention is characterized by the following configuration.

That is, an installing method for a part for registering a first part and a second part with a reference position for installing, wherein the first part is provided with a positioning portion for registering with a registration portion of the second part, the second part is provided with a protruded portion for registering with a positioning portion of the first part, an amount of deviation of the installation position of the second part from the reference position is measured, the protruded portion is worked by ultrasonic heating in accordance with the measured result, and the registration portion of the second part is corrected for installing.

An installing method for parts according to a third aspect of the present invention is characterized by the following configuration.

That is, an installing method for parts for registering a first part and a second part for installing, wherein the second part is provided with a protruded portion at a position corresponding to at least biaxial directions of X-axis and Y-axis at the installation position of the first part, amounts of machining of the protruded portion for installing the second part at the installation position of the first part are measured respectively, and the protruded portion is worked by ultrasonic heating in accordance with the results of measurement for registering the first and second parts for installing.

Other objects and advantages besides those discussed above shall be apparent to those skilled in the art from the description of a preferred embodiment of the invention which follows. In the description, reference is made to accompanying drawings, which form a part hereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a schematic structural view for a positioning apparatus for a butted-against portion of a molded item according to a first embodiment of the present invention;

FIGS. 2A to 2D are schematic views for a work;

FIGS. 3A to 3D are model views when the work is installed to the product body;

FIG. 4 is a top view for a correction working device;

FIG. 5 is a front view for the correction working device;

FIG. 6 is a right side view for the correction working device;

FIG. 7 is a block diagram for a control system;

FIG. 8 is a flow chart showing an operation of the positioning apparatus;

FIGS. 9A to 9C are explanatory views showing types of ultrasonic vibration;

FIG. 10 is an explanatory view showing ultrasonic vibration in the first embodiment;

FIGS. 11A to 11D are explanatory views showing shapes of a ultrasonic vibrator according to the first embodiment;

FIGS. 12A to 12D are explanatory views showing shapes of the ultrasonic vibrator according to the first embodiment;

FIG. 13 is a schematic structural view for a shaping apparatus according to a second embodiment of the present invention;

FIG. 14 is an explanatory view showing variations in an amount of deformation in the second embodiment according to the present invention;

FIG. 15 is a flow chart for explaining a procedure of the shaping operation in the second embodiment according to the present invention;

FIG. 16 is a schematic structural view for a state before the shaping operation in the shaping apparatus according to a third embodiment of the present invention;

FIG. 17 is a schematic structural view for a state after the shaping operation in the shaping apparatus according to the third embodiment of the present invention;

FIG. 18 is an enlarged view for a portion enclosed with dotted line in FIG. 17;

FIG. 19 is a flow chart for explaining a conventional procedure for shaping operation;

FIG. 20 is an explanatory view showing variations in an amount of deformation in the conventional shaping operation;

FIG. 21 is a flow chart for explaining a procedure of the shaping operation in the third embodiment according to the present invention; and

FIG. 22 is an explanatory view showing variations in an amount of deformation in the third embodiment according to the present invention.

### DETAILED DESCRIPTION OF THE PREFERRED EMBODIMENTS

Hereinafter, with reference to the accompanying drawings, the detailed description will be made of the preferred embodiments according to the present invention.

(First Embodiment)

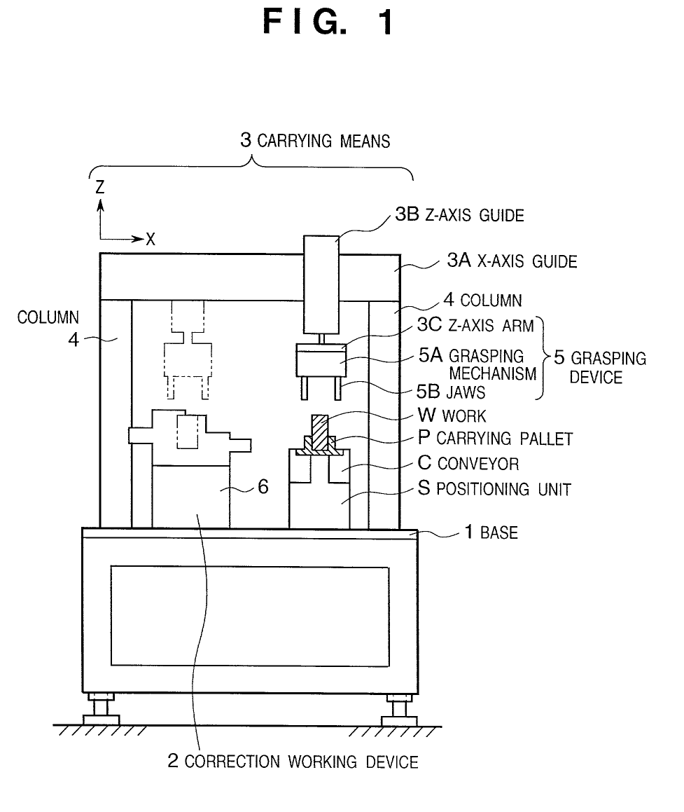

FIG. 1 is a schematic structural view for a positioning apparatus for a butted-against portion of a molded item according to the first embodiment of the present invention.

In FIG. 1, on a base 1, there is arranged a carrying mechanism 3 in a state in which it is supported by a pair of columns 4. The carrying mechanism 3 comprises: a X-axis guide 3A supported by the column 4; a Z-axis guide 3B capable of reciprocatively moving in the X-axis direction along the X-axis guide 3A; a Z-axis arm 3C capable of reciprocatively moving in the Z-axis direction along the Z-axis guide 3B; and a grasping device 5 which is hung down from the lower end of the Z-axis arm 3C. The Z-axis guide 3B and the Z-axis arm 3C are driven along the X-axis and the Z-axis respectively by a driving mechanism (not shown) so as to move the grasping device 5 on the base 1.

A correction working device 2 is fixed onto the base 1, and in the neighborhood thereof, a work-carrying conveyor C is arranged. The conveyor C carries a carrying pallet P for holding a work W in an axial direction perpendicular to the paper surface. On the base 1, there is provided a positioning unit S for positioning the carrying pallet P carried in by the conveyor C at a predetermined position for stopping.

The grasping device 5 has a grasping mechanism 5A and a pair of jaws 5B, and is constituted so that a work is grasped by the jaws 5B which are open-close driven by a driving mechanism (not shown) of the grasping mechanism 5A. The grasping device 5 is constituted so that it is lowered on the work W on a jig pallet P which has been positioned and stopped at a predetermined position on the conveyor C by the positioning unit S, the work W is grasped by the jaws 5B, is carried on the correction working device 2 by the carrying mechanism 3, and is lowered to be transferred to the correction working device 2.

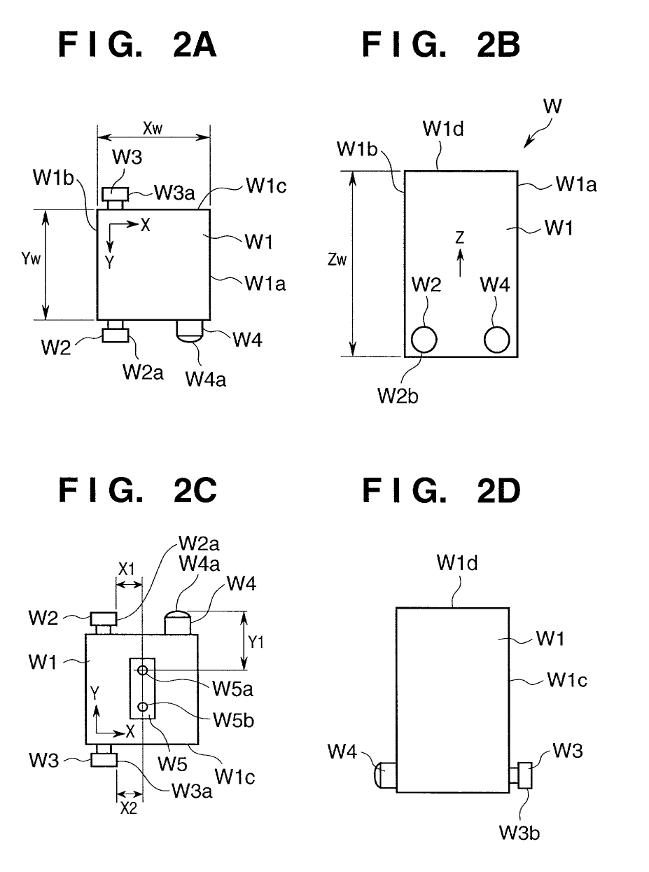

FIGS. 2A to 2D are schematic views showing the work W of the present embodiment, and a top view, a front view, a bottom view and a right side view respectively.

The work W has protruded portions W2, W3 and W4 which are integrally molded to a base W1 of a rectangular parallelopiped having outside dimensions of Xw, Yw and Zw. A work W5 is installed to the base W1 with several parts (not shown) interposed therebetween. Also, in the work W5, there are formed holes W5a and W5b whose positional accuracy should be obtained when it is installed to the product body.

When installing the work W to the product body W0, the work W is installed with three places of W1a, W2a and W3a in the X direction, one place of W4a in the Y direction, and two places of W2b and W3b in the Z-direction respectively as butted-against references, and is held by applying predetermined loads to portions of W1b, W1c and W1d in the respective directions.

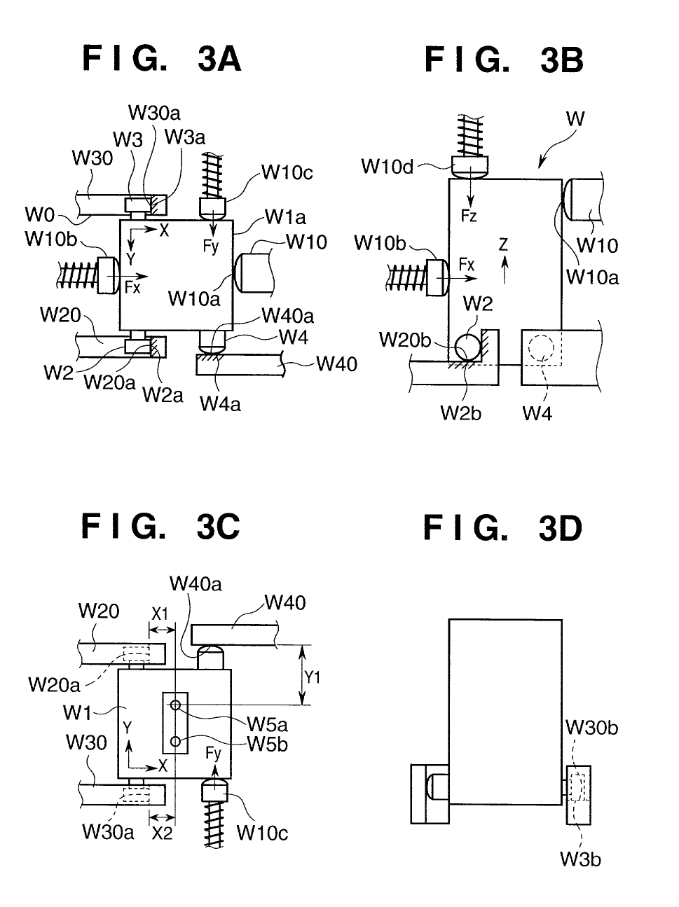

FIGS. 3A to 3D are model views when the work W according to the present embodiment is installed to the product body W0, and are a top view, a front view, a bottom view and a right side view respectively. Three places of W1a, W2a and W3a in the X direction of the work W, one place of W4a in the Y direction, and two places of W2b and W3b in the Z direction are, as butted-against references, butted against three place of W10a, W20a and W30a in the X direction, one place of W40a in the Y direction and two places of W20b and W30b in the Z direction and are installed respectively, which have been provided for members W10, W20, W30 and W40 of the product body W0 respectively. The work W is held by clamp members W10b, W10c and W10d having a known spring mechanism respectively using predetermined loads Fx, Fy and Fz.

The approximate dimensions of the work W are Xw=40 mm, Yw=40 mm, and Zw=80 mm, and the protruded portions W2 and W3 have a diameter of 4 mm and a height of 2 mm, and W4 has a diameter of 5 mm and a height of 2 mm. The holes W5a and W5b have a diameter of about 0.02 mm and a hole pitch of about 12 mm. The load Fx is about 1.8 kgf, Fy is 3.0 kgf, and Fz is about 2.5 kgf. The work W is a molded item made of thermoplastic resin.

The areas to be positioned in the present embodiment are, with the holes W5a and W5b as the reference in FIG. 2C, three places: a dimension X1 up to a butted-against portion W2a in the X direction, a dimension X2 up to a butted-against portion W2b in the X direction, and a dimension Y1 up to a butted-against portion W4a in the Y direction. The respective dimensions are X1=10 mm, X2=10 mm and Y1=15 mm, and the positioning accuracy based on correction working is ±0.01 mm or less respectively.

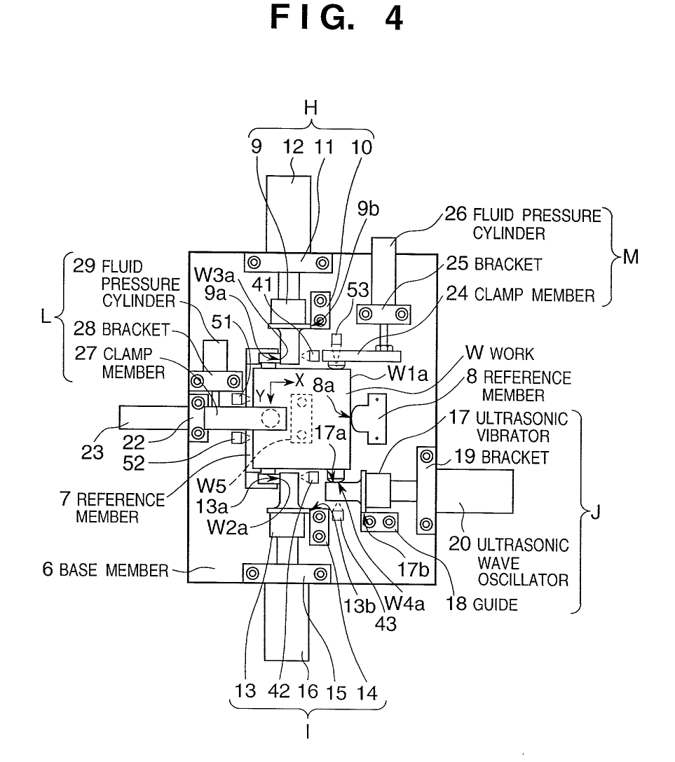

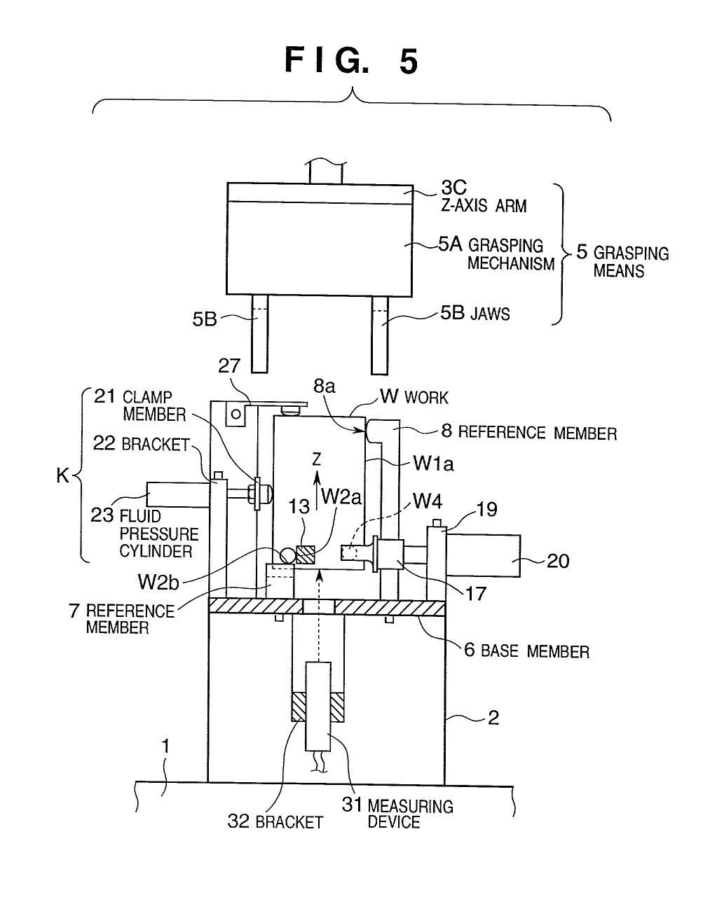

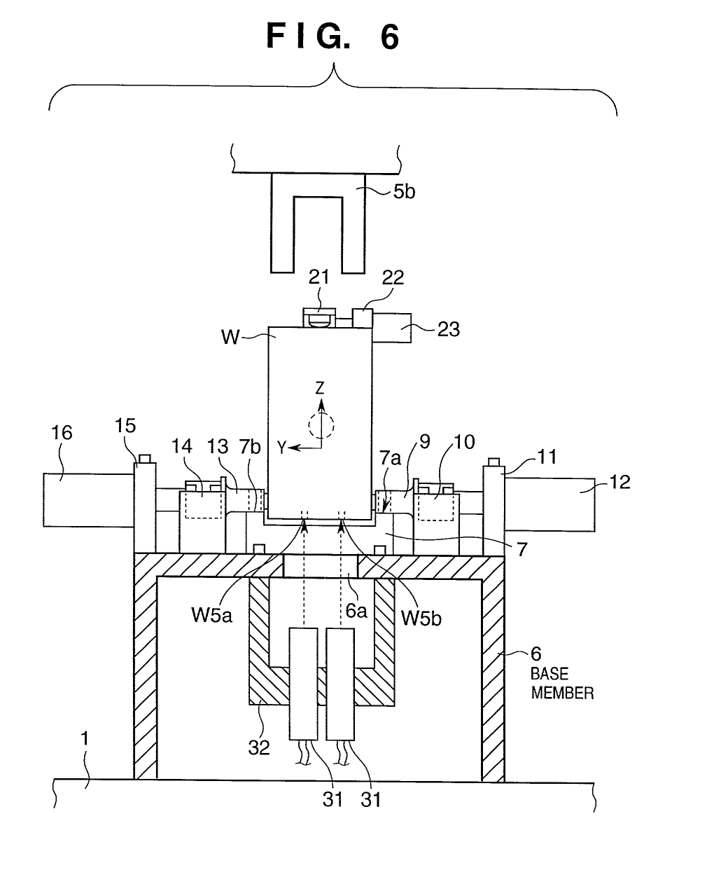

FIGS. 4, 5 and 6 are a top view, a front view and a right side view showing a correction working device 2 according to the present embodiment respectively.

In FIGS. 4 to 6, butted-against portions W1a, W2b and W3b, which are not positioned, of the work W transferred to a predetermined position on the base member 6 placed on the base 1 are butted against the portion 8a of a reference member 8 and portions 7a and 7b of a reference member 7 which have been fixed onto the base member 6 respectively. Also, butted-against portions W2a, W3a and W4a, in the work W, to be positioned are butted against side surfaces 9a, 13a and 17a of the vibrators of ultrasonic vibrators 9, 13 and 17 of ultrasonic oscillating devices H, I and J respectively.

The ultrasonic vibrators 9, 13 and 17 of the ultrasonic oscillating devices H, I and J are connected to ultrasonic wave oscillators 12, 16 and 20 respectively, and the ultrasonic wave oscillators 12, 16 and 20 are fixed onto the base member 6 through brackets 11, 15 and 19 respectively. By guides 10, 14 and 18 fixed onto the base member 6, the non-vibration points (maximum stress points) 9b, 13b and 17b of the ultrasonic vibrators 9, 13 and 17 are supported without affecting ultrasonic vibration caused by the vibrators.

The work W is, as in case of the product body WO, pressed and pressurized by pressing pressurizing devices K, M and L in the X, Y and Z directions respectively. The pressing pressurizing devices K, M and L have clamp members 21, 24 and 27 respectively, and these clamp members are connected to fluid pressure cylinders 23, 26 and 29 fixed to the base member 6 through brackets 22, 25 and 28 respectively, and are driven by the fluid pressure cylinders 23, 26 and 29. The fluid pressure cylinders 23 and 26 are of a direct-acting type, and the fluid pressure cylinder 29 is of a rotating type.

Setting of the pressing pressurized load using the clamp members 21, 24 and 27 is, according to the present embodiment, performed by adjusting the fluid pressure in the fluid pressure cylinders 23, 26 and 29 to the same load as that in a state, in which it has been installed in the product body W0, by a pressure regulating valve, but it may be performed using a known spring mechanism.

At the abutted portion between the clamp members 21, 24 and 27 and the work W, a known rolling mechanism may be provided so that the pressing pressurizing can be reliably performed.

Under the base member 6, a measuring device 31 for measuring the positions of the holes W5a and W5b of the work W5 is mounted through a bracket 32. On the base member 6, a hole 6a is bored to measure the holes W5a and W5b of the work W5. The measuring device 31 is to measure by capturing images with two CCD cameras in total, one camera for each of the holes W5a and W5b for image processing judging from the required precision and the shape of areas to be measured in the present embodiment.

Further, in the present embodiment, in order to measure variations in position caused by loads applied to the ultrasonic vibrators 9, 13 and 17, there are provided second measuring devices 41, 42 and 43 fixed to the base member 6 by members (not shown) respectively. The second measuring devices 41, 42 and 43 use laser distance meters because of the required precision and their excellent ease of use in the present embodiment.

Further, in the present embodiment, in order to measure an amount of working, there are provided third measuring devices 51, 52 and 53 fixed to the base member 6 by members (not shown) in addition to the measuring device 31. The third measuring devices 51, 52 and 53 use, in the present embodiment, laser distance meters because of the required precision and their excellent ease of use.

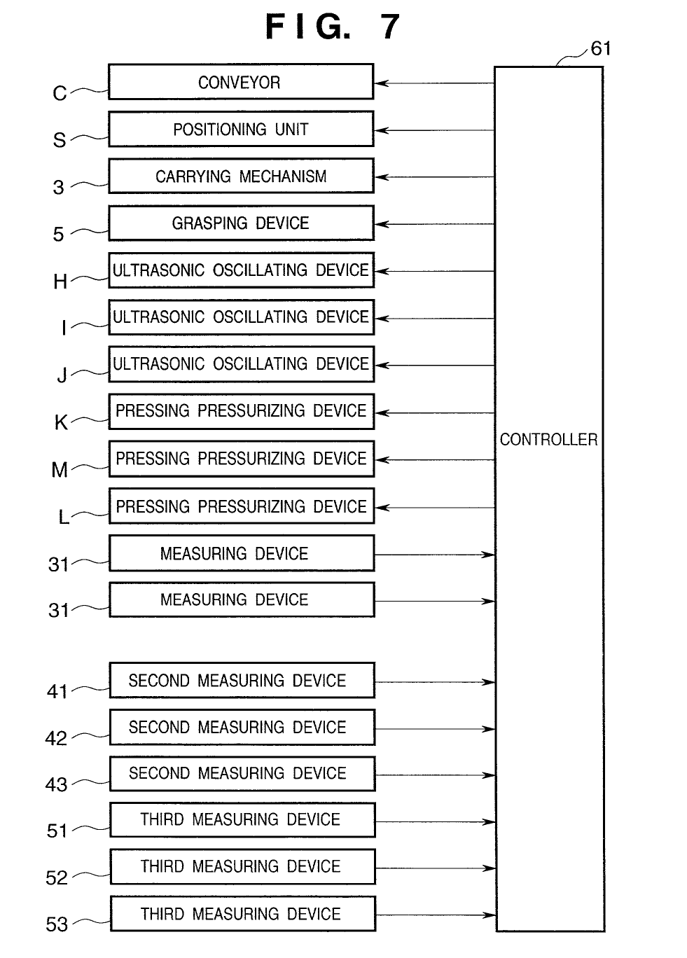

FIG. 7 is a control block diagram in which the operations of each device described above are controlled, and each device is drivingly controlled by a controller 61.

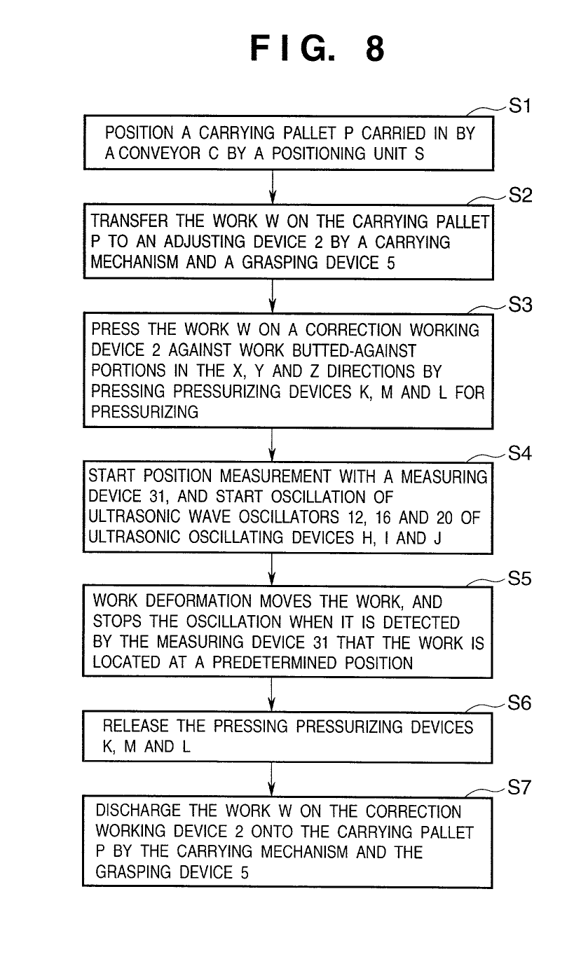

Next, with reference to FIGS. 1 to 7 and the flow chart shown in FIG. 8, the description will be made of the operation of a positioning apparatus constituted as described above.

First, a carrying pallet P carried in by a conveyor C is positioned and stopped at a predetermined position on the conveyor C by the positioning unit S (Step 1).

Next, the grasping device 5 is caused to lower on the work W on the jig pallet P, the work W is grasped by the jaws 5B, the grasping device 5 is raised, and then the grasping device 5 is moved on the correction working device 2 by the carrying mechanism 3. Thus, the grasping device 5 is caused to lower as it is, the grasping of the work W by the grasping device 5 is released, and the grasping device 5 is raised to complete the transfer of the work W from the jig pallet P to the correction working device 2 (Step 2).

Next, the fluid pressure cylinder 23 is caused to operate, and the clamp member 21 is caused to advance and operate to thereby press the work W in the X direction for pressurizing. Subsequently, the fluid pressure cylinder 26 is caused to operate and the clamp member 24 is caused to advance and operate to thereby press the work W in the Y direction for pressurizing. Subsequently, the fluid pressure cylinder 29 is caused to operate and the clamp member 27 is caused to rotationally advance and operate to thereby press the work W in the Z direction for pressurizing. The foregoing operations cause the butted-against portions of the work W to be closely butted against the reference members 7 and 8 and the ultrasonic vibrators 9, 13 and 17 to complete the clamp operation of the work W (Step 3).

In the system of the present embodiment, the posture in the transfer-completed state in the Step 2 is unstable depending upon the shape of the work, and therefore, it is conceivable that the butted-against portion of the work W in the Step 3 is not closely butted against, and in this case, it is advisable to provide temporarily-receiving means, having a cushioning mechanism, for the work W so that the work W is not affected by butting-against and the movement of the work during working.

Position measurement for holes W5a and W5b in the work W5 is started by the measuring device 31, and the ultrasonic wave oscillators 12, 16 and 20 in the ultrasonic oscillating devices H, I and J are caused to operate. Thus, heat generation in butted-against references W2a, W3a and W4a of the work W, which are in contact with the ultrasonic wave vibrators 13, 9 and 17 respectively, is started by the ultrasonic vibration generated in the ultrasonic wave vibrators 9, 13 and 17 (Step 4).

The work W, against which the butted-against references are pressed, starts to move on the vibrator side respectively by heat deformation of the buttedagainst reference W2a, W3a and W4a based on the heat generated. Next, when it is detected by the measuring device 31 that the positions of the holes W5a and w5b in the work W5 are at predetermined positions, the oscillation of the ultrasonic wave oscillators 12, 16 and 20 is stopped. Actually, since deformation of several μm to several tens μm continues until the heat deformation area is cooled and the heat deformation is stopped since the stoppage of oscillation, a stop signal is issued taking it into consideration. By the foregoing operations, the positioning to predetermined dimensions based on the working using ultrasonic vibration at the butted-against portions is completed (Step 5).

In this respect, in the present embodiment, a dummy work, which constitutes a master in accuracy, is used as means for obtaining positional relationship between the ultrasonic vibrators and the measuring device.

Next, the fluid pressure cylinders 23, 26 and 29 are caused to operate, and the pressing pressurization on the work W in the X, Y and Z directions is released by retracting operations of the clamp members 21, 24 and 27 (Step 6).

Next, the grasping device 5 is caused to lower on the work W on an adjusting device 2, the work W is grasped by the jaws SB, and the grasping device 5 is raised to move the grasping device 5 on the jig pallet P by the carrying mechanism 3. The grasping device 5 is caused to lower as it is, the holding of the work W by the grasping device 5 is released, and the grasping device 5 is raised to complete the discharge of the work W from the correction working device 2 to the jig pallet P (Step 7).

Hereinafter, the operations of the foregoing Step 1 to Step 7 are repeated.

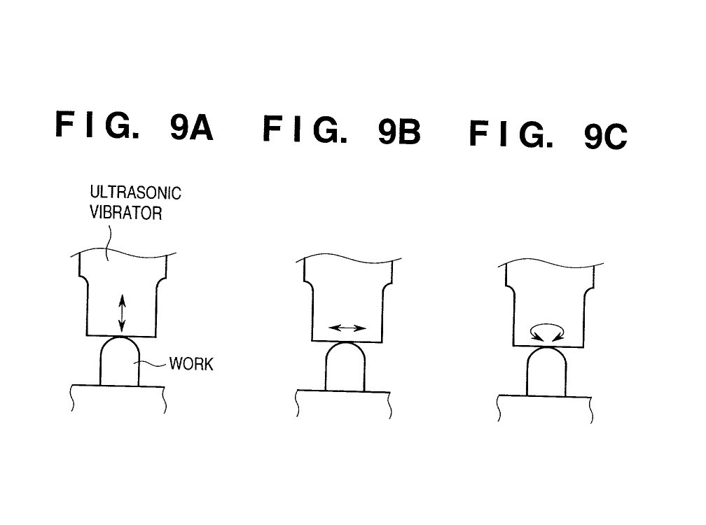

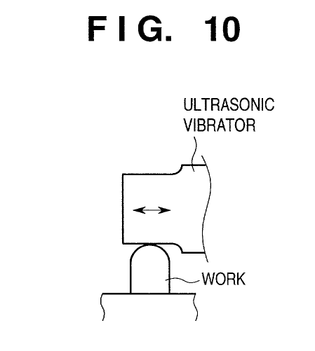

For types of vibration of the ultrasonic wave oscillator, longitudinal vibration (FIG. 9A), transverse vibration (FIG. 9B) and torsional vibration (FIG. 9C) can be considered. In the present embodiment, the side surface of the vibrator, which longitudinally vibrates as shown in FIG. 10, is used, and the vibrator is adapted to come into contact with the work in the transverse vibration by taking into consideration that it is difficult to cause a damage to the work, and the layout of the ultrasonic vibrators with respect to the work.

As regards the oscillation frequency, in order to prevent any adverse effect of the ultrasonic vibration on any portions of the work W other than the butted-against portions, and erroneous measurement of the measuring device due to vibration at the measuring areas, 60 KHz, a higher frequency than used in ordinary solvent welding has been adopted so as to make the transfer distance of the vibration to the work W short. The amplitude is about 20 μm.

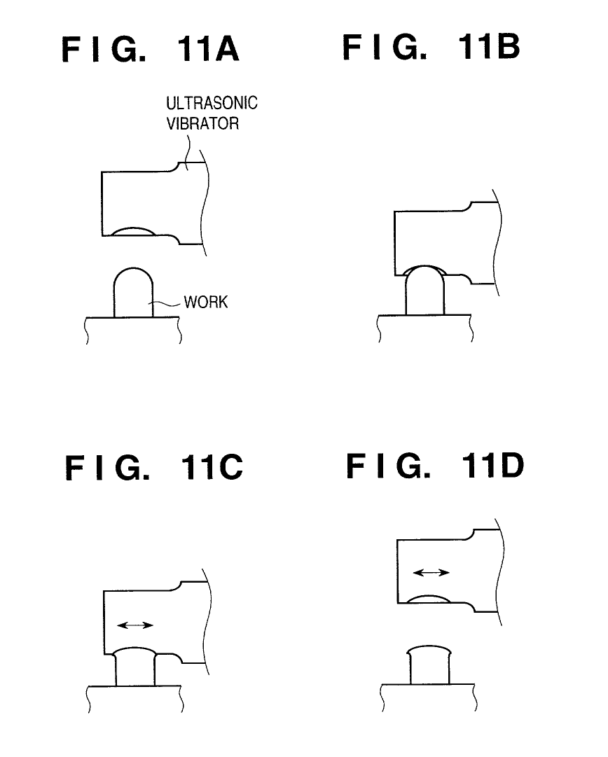

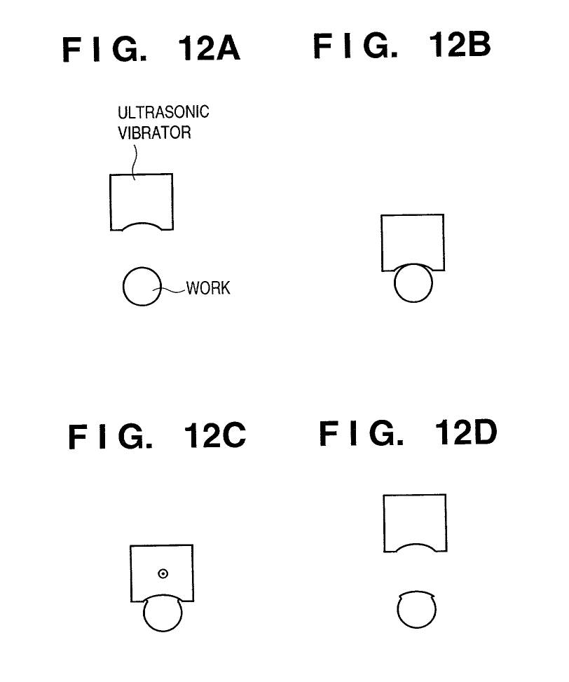

As regards the shape of the ultrasonic vibrator, in such a manner that the butted-against portions of the work W are formed into a radius shape in order to obtain stability in butting-against between the work W and the product body W0, the portion W4 of the work W was shaped as shown in FIGS. 11A to 11D, and the portions W2 and W3 of the work W were shaped as shown in FIGS. 12A to 12D respectively. FIGS. 11A and 12A show a state before the pressing pressurization, FIGS. 11B and 12B show a state when pressing pressurization has been made, FIGS. 11C and 12C show a heat-deformed state by ultrasonic oscillation, and FIGS. 11D and 12D show a state of completed adjustment in the present embodiment.

Time between Step 4 and Step 5 in the present embodiment was about 2 seconds in a case where the necessary and maximum amount of working is 0.3 mm, which was supposed in the present embodiment.

Also, it is considered that the pressing pressurizing force may be insufficient depending upon the work so that it takes time to generate heat and to deform by ultrasonic oscillation, and in this case, the pressing pressurizing force during working can be temporarily increased by a method of switching the pressure regulating valve for the pressing pressurizing device, or the like. It is, however, necessary to correct the amount of working in consideration of a difference in the amount of deformation due to a difference in the pressurizing force.

In the present embodiment, the working is simultaneously performed at three places, but depending upon problems in the treatment in the measuring device, the shape of the work and the like, there may be suitable a method of dividing the working such as, if the present embodiment is exemplified, first working the two places in the X direction, and thereafter, working the remaining one place in the Y direction.

Also, depending upon the pressing pressurizing force and the required precision, it is necessary to take into consideration displacement of the ultrasonic vibrator due to the pressurizing force applied to the ultrasonic vibrator, or the hysteresis characteristic of position of the ultrasonic vibrator, and in this case, the working dimensions can be corrected by feeding back the data of the second measuring devices 41, 42 and 43 to the working data obtained by the measurement concerning the positions of the ultrasonic vibrators in the present embodiment.

Further, depending upon the contents of measurement of the work W, in the case of measuring the position printed on a sheet or the like as in case of, for example, a printer head, by the measuring device 31, and adjusting on the basis of the data, it is difficult to control the timing for stoppage of oscillation of ultrasonic wave only by the measuring device 31. Or, depending upon the system of the measuring device 31, it is considered that it may be advantageous in the cycle time to stop the oscillation by controlling the amount of working using ultrasonic wave by another measuring device after the amount of working is measured by the measuring device 31 in advance owing to long sampling time for measurement. In this case, as described in the present embodiment, there can be provided third measuring devices 51, 52 and 53 for measuring the moving amount during working of the work W to control timing for stoppage of oscillation of the ultrasonic wave.

In the present embodiment, during working using ultrasonic vibration, any working foreign matter was hardly generated and was at a level at which there are no problems in practical use, but it is considered that working foreign matter may be generated, although in trace amounts, depending upon the conditions such as work material. In this case, since chips do not scatter by a large distance in the present working system unlike in the cutting work, it can be easily solved by taking simple measures such as provision of a dust collecting mechanism.

In this respect, in the above-described description, the description has been made of the case where butted-against portions of the molded item are corrected (positioned) by ultrasonic vibration, but the present invention is not limited thereto, but it is applicable to positioning of a positioning portion in the case of positioning by any other than butting-against.

As described above, according to the present embodiment, clean positioning free of chips with a high precision can be implemented in a conventional integrally-molded work form through the use of ultrasonic vibration as working means of finishing butted-against portions of a molded item into predetermined dimensions by working.

Also, by pressing butted-against portions of a molded item against the vibrator of a ultrasonic wave oscillator fixed for working by pressurizing, simple positioning can be implemented at low cost.

Also, with the provision of measuring means for measuring adjustment dimensions of a molded item, simple automated positioning can be implemented at low cost.

Also, with the provision of second measuring means for measuring the position of a ultrasonic vibrator, positioning with higher accuracy can be implemented.

Also, with the provision of third measuring means for measuring an amount of working of a molded item, positioning having a higher degree of freedom in which the measuring means is not limited can be implemented.

Also, by measuring while butted-against portions of a molded item are butted against the ultrasonic vibrator to continuously work the butted-against portions to working dimensions obtained by the measurement in that state, automated positioning can be implemented simply at low cost, at high speed, and with high accuracy.

Also, faster positioning can be implemented by working into predetermined dimensions while measuring with the butted-against portions of a molded item butted against the ultrasonic vibrator.

Also, very reliable positioning can be implemented by measuring and working while the same load as in a state where it is installed to the product is applied to the butted-against portions of the molded item.

Also, very fast positioning can be implemented by working the butted-against portions of a molded item at a plurality of portions at the same time.

As described above, according to the first embodiment, in order to implement the required precision for a product of a single part using molded items to a product constituted by a combination of a plurality of parts, there are proposed a new positioning method and an apparatus therefor using ultrasonic wave, whereby it is possible to implement clean, simple, very fast and high precision positioning, and to implement reduction of number of parts for the product, simplification, cost reduction in the production equipment, and cost reduction in the product at a high level.

(Second Embodiment)

In the above-described first embodiment, there have been proposed a method for heat-deforming a shaping area of a molded item by ultrasonic vibration for shaping, and an apparatus therefor. According to such a shaping method, the molded item can be simply shaped (positioned).

In a case, however, where the molded item is heat-deformed by ultrasonic vibration, the present inventors, et al. found out that the deformation of the molded item does not stop immediately even if the ultrasonic vibration is stopped. More specifically, it was found out that after the ultrasonic vibration of the molded item is stopped, the molded item is deformed over a range of, for example, several μm to several tens μm in accordance with conditions such as its material, shape, and amount of deformation.

This second embodiment takes into consideration also the deformation of the molded item after the ultrasonic vibration is stopped.

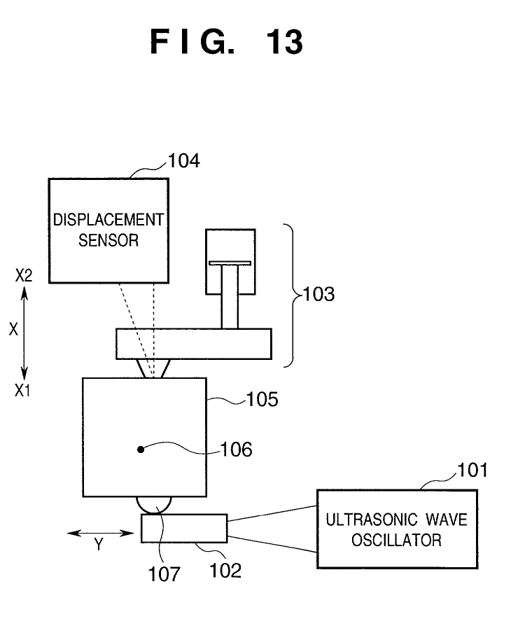

FIG. 13 is a schematic structural view showing a shaping apparatus according to the second embodiment. In FIG. 13, a ultrasonic vibrator 102, which is vibrated in a direction indicated by an arrow Y, is mounted to a ultrasonic wave oscillator 101 fixed at a fixed position. A reference numeral 105 designates a work as a molded item, and is adapted to be installed to the product with its work butted-against portion 107 as a reference. This work 105 is pressed in a direction indicated by an arrow X1 by a work pressing mechanism 103 so that the butted-against portion 107 as the shaping area is pressed against the ultrasonic vibrator 102. A displacement sensor 104 continuously measures a moving amount of the work 105 in a direction indicated by an arrow X to thereby measure the amount of deformation of the butted-against portion 107. A CCD camera and an image processing device, which are not shown, are capable of detecting the position of a reference hole 106 formed on the work 105.

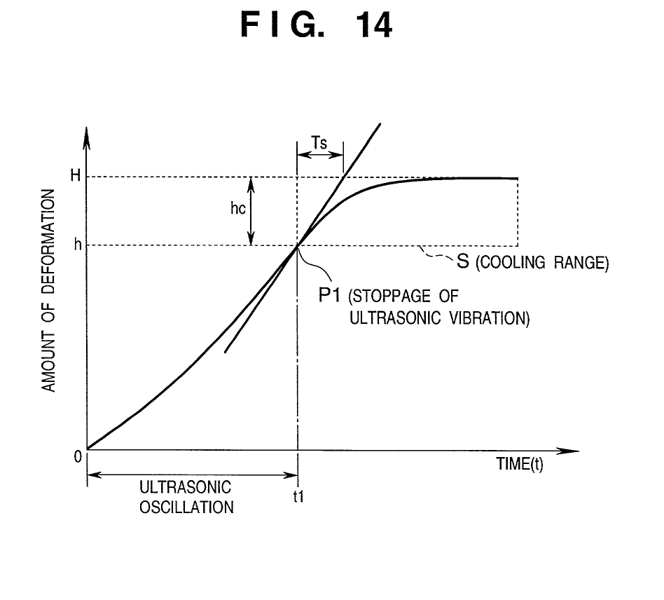

FIG. 14 shows a deformation curve when the butted-against portion 107 of the work 105 is heat-deformed by ultrasonic vibration of the ultrasonic vibrator 102 in a direction indicated by an arrow Y to thereby shape the butted-against portion 107. In FIG. 14, the abscissa shows elapsed time t after excitation of the butted-against portion 107 by the ultrasonic vibrator 102, and the ordinate shows an amount of deformation of the butted-against portion 107 measured by the displacement sensor 104.

By applying ultrasonic vibration to the butted-against portion 107, the deformation caused by heat deformation of the butted-against portion 107 advances. At a point of time t1 whereat the ultrasonic vibration of the ultrasonic vibrator 102 is stopped, the deformation of the butted-against portion 107 is not stopped, but even thereafter, the deformation of the butted-against portion 107 advances as shown by a curve drawn from point P1 in FIG. 14. In the case of taking notice of a cooling range S indicated by dotted line in FIG. 14 after the stoppage of the ultrasonic vibration, the deformation of the butted-against portion 107 advances as shown by a curve approximated to an exponential curve. The curve within the cooling range S approximates to the exponential curve, whereby an amount of deformation hc after the stoppage of the ultrasonic vibration can be determined by a product of a deformation velocity V (corresponds to the inclination of an oblique straight line passing through the point P) at point P1 and a time constant Ts.

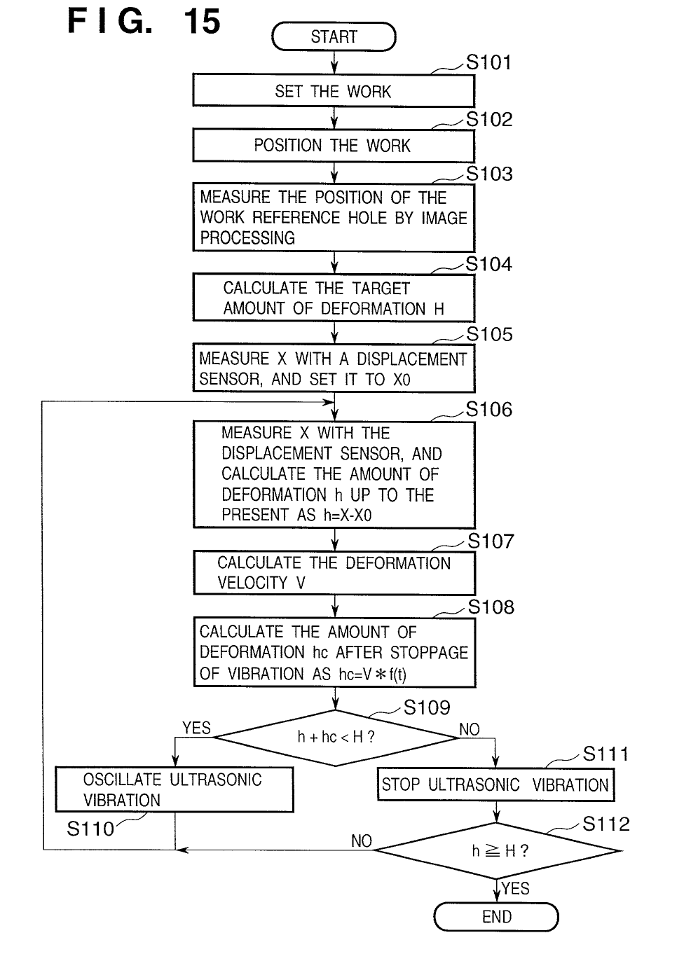

FIG. 15 is a flow chart for explaining a procedure of the shaping method.

Step S101; The work 105 is first set manually or using a robot or the like.

Step S102; The work 105 is positioned using the work pressing mechanism 103.

Step S103; The position of the reference hole 106 in the work 105 is measured using a CCD camera and an image processing device which are not shown.

Step S104; The target amount of deformation H (See FIG. 14) is calculated. The target amount of deformation H can be calculated from a difference between the position of the reference hole 106 corresponding to the target dimension of the work 105 set in advance and the position of the reference hole 106 measured at the Step S103. This target amount of deformation is, for example, 150 μm in the present embodiment.

Step S105; The position of the work 105 in the X direction before shaping is started is measured using the displacement sensor 104, and it is set to a reference position X0.

Step S106; The position X of the work 105 in the X direction at the present moment is measured using the displacement sensor 104, and from the position X at the present moment and the reference position X0, the amount of deformation h up to the present moment is calculated by the following equation (1). This amount of deformation h is, for example, 136 μm or the like.

h=X−X0 (1)

Step S107; On the basis of a difference (X−X′) between the previous measured value X′ and this measured value X using the displacement sensor 104, and the time interval T0 between at those time of measurement, the deformation velocity V is calculated from the following equation (2):

V=(X−X′)/T0 (2)

where T0 is the process interval time for control, and is set to 10 msec. This deformation velocity V is, for example, 100 μm/sec in the present embodiment. Also, the material of molded item worked is made of modified polyphenylene ether (PPE), polyphenylene oxide (PPO) or the like in the present embodiment, and the ultrasonic frequency is 60 KHz, and the amplitude is 20 μm.

Step S108; The amount of deformation hc after the stoppage of ultrasonic vibration is predicted and calculated by the following equation (3):

hc=V·f(t) (3)

It is assumed that f(t)=A·t; where t is elapsed time from the Step S105, and A is a constant (for example, 100 msec/sec in the present embodiment). “t” corresponds to elapsed time (for example, 1.36 sec in the present embodiment) from the commencement of vibration of the butted-against portion 107 to the present moment, and f(t) is a monotone increase function of the time t. The amount of deformation hc after the stoppage of the ultrasonic wave is for example, 13.6 μm or the like from the above-described numerical values.

Step S109; (h+hc) is compared with the target amount of deformation H, and if h+hc<H, the process proceeds to the Step S110. And if h+hc≧H, the process proceeds to Step S111.

Step S110; The ultrasonic vibrator 102 is vibrated by the ultrasonic wave oscillator 101. After measuring the reference position X0 at the Step S105, the process is to proceed to this Step S110 because h+hc<H at the initial points of time whereat the process proceeds to the Steps S106, S107, S108 and S109.

Step S111; The vibration of the ultrasonic vibrator 102 is stopped by the ultrasonic wave oscillator 101.

Step S112; It is determined whether or not the amount of deformation h reaches the target amount of deformation H, and if not, the process returns to the Step S106. The Steps S106 to S112 are executed at every 10 msec control cycle. If the amount of deformation h reaches the target amount of deformation H, the shaping operation will be terminated.

Thereafter, the work pressing mechanism 103 can be released to take out the work 105. Thus, the shaping operation for the butted-against portion 107 of one work 105 is terminated.

In this respect, in the Step S107, on calculating the deformation velocity V, the deformation velocity can be obtained more accurately by calculating on the basis of not only the previous and this measured values of the displacement sensor 104, but also the measured values for several times in the past thereof. For example, the tendency of change can be determined from the rate of change of measured values for several times in the past to obtain the deformation velocity V more accurately.

Also, in the Step S108, it is also possible to calculate the amount of deformation hc after the stoppage of the vibration by the following equation (3′):

hc=V·f(h) (3′)

It is assumed that f(h)=A·h (A is a constant) Where h is an amount of deformation from the commencement of vibration of the butted-against portion 107 to the present moment, and f(h) is a monotone increase function of the amount of deformation h.

(Third Embodiment)

The present embodiment is an example of application in the case where the work 105 is melt-deformed by ultrasonic vibration at plural places for shaping them.

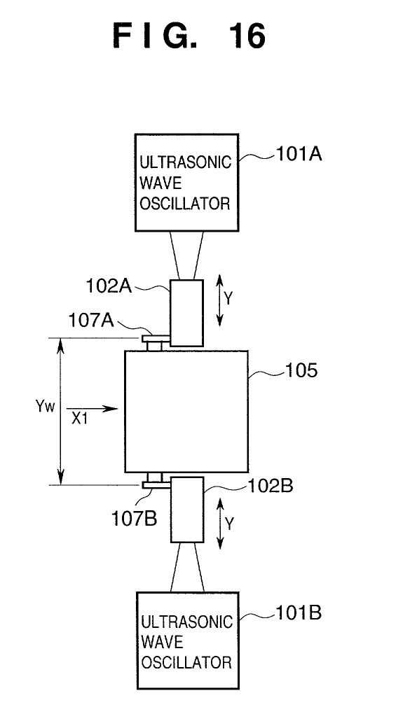

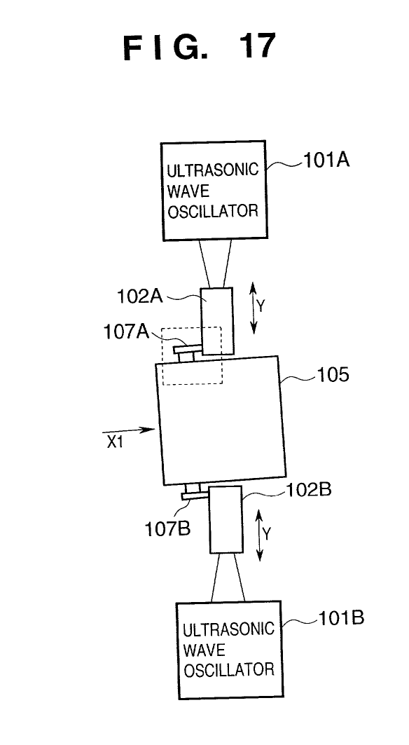

FIGS. 16 and 17 are schematic structural views showing a shaping device for shaping the butted-against portions 107A and 107B at two places of the work 105, and the butted-against portion 107A is shaped by the ultrasonic vibrator 102A which is vibrated by the ultrasonic wave oscillator 101A in a direction indicated by an arrow Y while the butted-against portion 107B is shaped by the ultrasonic vibrator 102B which is vibrated by the ultrasonic wave oscillator 101B in a direction indicated by an arrow Y. The work 105 is pressed from a direction indicated by an arrow X1.

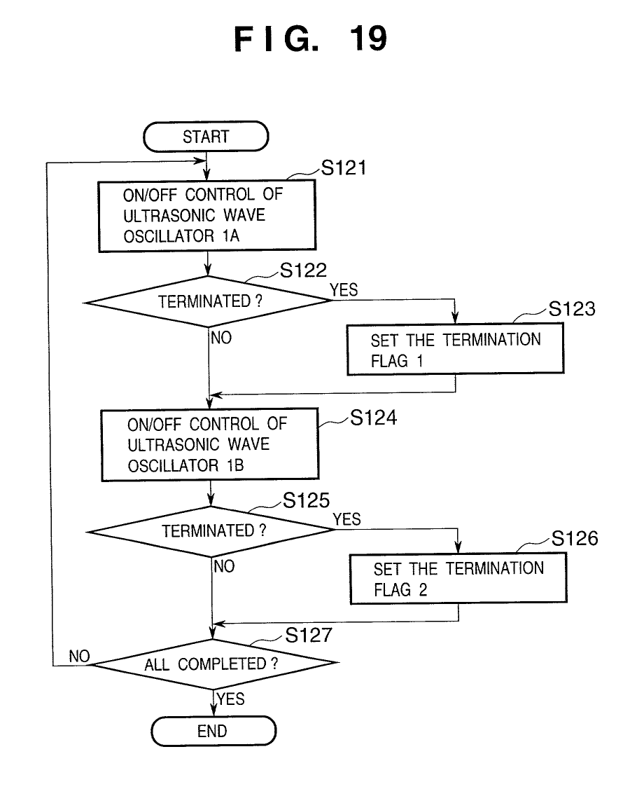

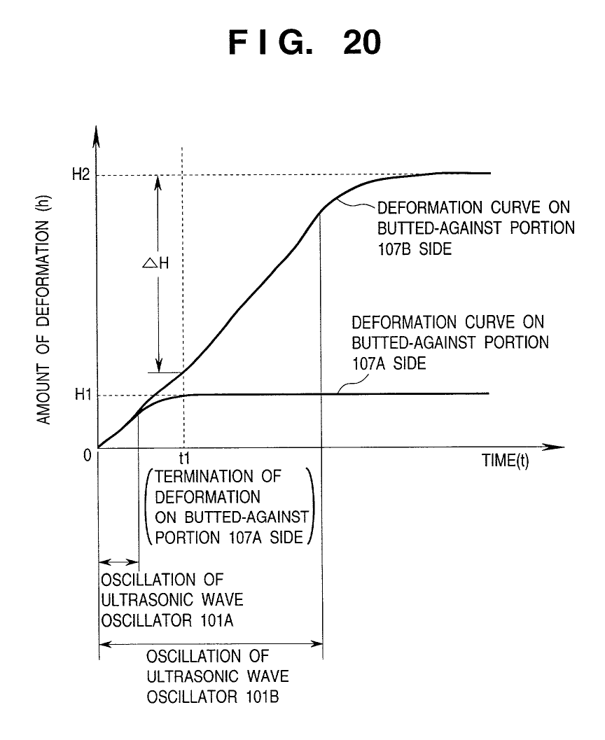

In the comparative example, shaping (Step S121) of the butted-against portion 107A by ON/OFF control of the ultrasonic wave oscillator 101A and shaping (Step S124) of the butted-against portion 107B by ON/OFF control of the ultrasonic wave oscillator 101B are performed in parallel as shown in FIG. 19. At the termination of those shaping operations, termination flags 1 and 2 are set (Steps S122 and S123, and Steps S125 and S126), and when those termination flags 1 and 2 are both set, the shaping operations are adapted to be terminated (Step S127). If the target amount of deformation H1 of the butted-against portion 107A is smaller than the target amount of deformation H2 of the butted-against portion 107B, the deformation of the butted-against portion 107A will be terminated earlier, and thereafter, the deformation of the butted-against portion 107B will be terminated as shown in FIG. 20. In FIG. 20, the deformation of the butted-against portions 107A and 107B will advance as in the case of the foregoing second embodiment after the stoppage of oscillation of the corresponding ultrasonic wave oscillators 101A and 101B. Also, the butted-against portion 107A will be adversely affected even after termination of its deformation by the deformation of the butted-against portion 107B.

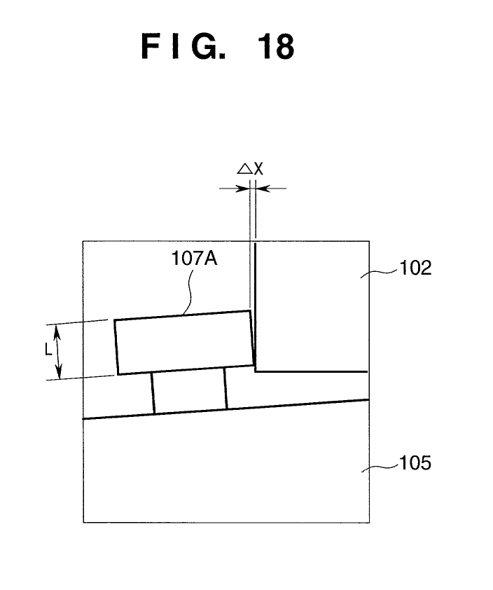

FIG. 18 is an enlarged view for a portion enclosed with dotted line in FIG. 17 for explaining such butted-against portion 107A, even after the termination of its deformation, adversely affected by the deformation of the butted-against portion 107B. Since the work 105 leans because of the deformation of the butted-against portion 107B after the termination of the deformation of the butted-against portion 107A, the contact surface of the butted-against portion 107A is shifted by ΔX in FIG. 18 to cause a gap. The gap ΔX can be determined by the following equation (4):

ΔX=L·(H2−H1)/Yw (4)

where Yw and L are dimensions of the work 5 (See FIGS. 16 and 18). H1 is the target amount of deformation of the butted-against portion 107A and H2 is the target amount of deformation of the butted-against portion 107B. As a concrete example, when Yw=40 mm, L=1 mm, H1=50 μm, and H2=300 μm, ΔX became 12.5 μm, and there was a limit to the shaping accuracy of the work 105 by that much.

The third embodiment according to the present invention thus improves the shaping accuracy of the work 105 by solving the problem in a case where the butted-against portions 107A and 107B are shifted by a large distance at the termination of their deformation.

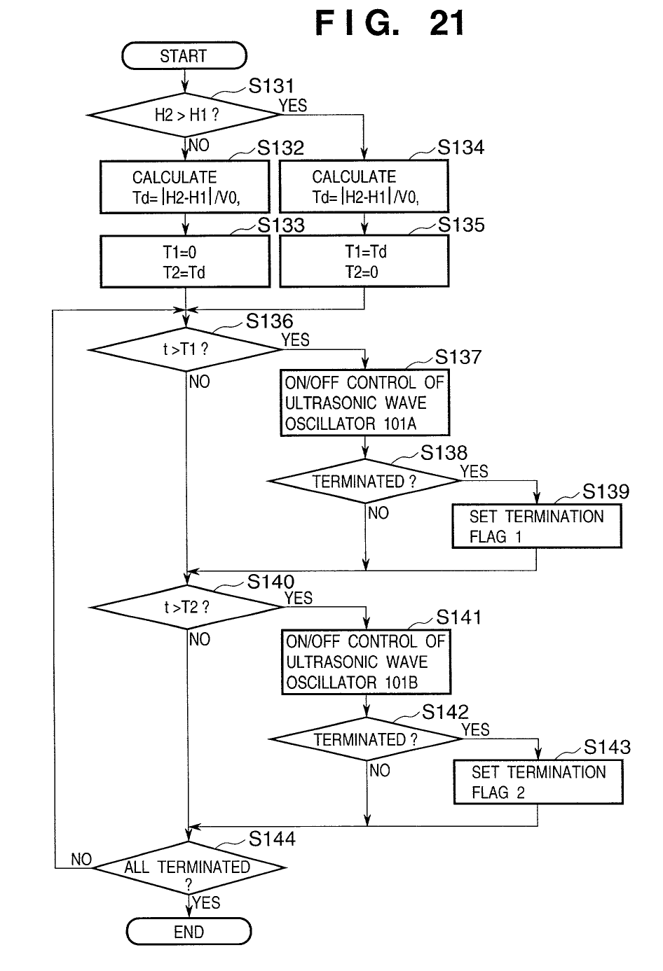

FIG. 21 is a flow chart for explaining the procedure of the shaping operation in the present embodiment.

Step S131; The target amount of deformation H1 of the butted-against portion 7A is compared with the target amount of deformation H2 of the butted-against portion 7B in size, and if H1 is equal to or larger than H2, the process proceeds to a Step S132, and if H1 is smaller than H2, the process proceeds to a Step S134.

Step S132; From the difference |H2−H1| between the target amounts of deformation, and the average deformation velocity V0, delay time Td at the commencement of shaping of the butted-against portion 107B having a smaller target amount of deformation is calculated by the following equation (5). The average deformation velocity V0 is assumed to be constant.

Td=|H2−H1|/V0 (5)

The average deformation velocity V0 can be determined by shaping the butted-against portions of several works 105 in advance. Also, this average deformation velocity V0 is determined by the material of the work 105, the shape of the butted-against portions 107A and 107B, the pressurizing force to the butted-against portions 107A and 107B in a direction indicated by an arrow X1, the amplitude and frequency and the like of the ultrasonic vibrators 102A and 102B, and all almost of those factors can be made constant.

Step S133; Vibration start time T0 of the butted-against portion 107A having a larger target amount of deformation is set to “0,” and vibration start time of the butted-against portion 107B having a smaller target amount of deformation is set to “Td.”

Step S134; From the difference |H2−H1| between the target amounts of deformation, and the average deformation velocity V0, delay time Td at the commencement of vibration of the butted-against portion 107A having a smaller target amount of deformation is calculated by the above equation (5).

Step S135; Vibration start time T0 of the butted-against portion 107B having a larger target amount of deformation is set to “0,” and vibration start time of the butted-against portion 107A having a smaller target amount of deformation is set to “Td.”

Step S136; The present time t is compared with vibration start time T1 of the butted-against portion 107A, and when the vibration start time T1 is reached, the process proceeds to a Step S137.

Step S137; The ultrasonic wave oscillator 101A is ON/OFF controlled to vibrate the butted-against portion 107A for shaping. On shaping, the ultrasonic wave oscillator 101A is controlled, as in the case of the foregoing second embodiment, in consideration of the amount of deformation of the butted-against portion 107A after the stoppage of the ultrasonic wave to deform the butted-against portion 107A into the target amount of deformation H1.

Step S138; It is determined whether or not the butted-against portion 107A has been shaped into the target amount of deformation H1. On determining, the deformation after the stoppage of the ultrasonic vibration is taken into consideration as in the case of the foregoing second embodiment. If the shaping of the butted-against portion 107A has not yet been terminated, the process proceeds to a Step S140, and if it has been terminated, the process proceeds to a Step S139.

Step S139; A termination flag 1 is set.

Step S140; The present time t is compared with vibration start time T2 of the butted-against portion 107B, and when the vibration start time T2 is reached, the process proceeds to a Step S141.

Step S141; The ultrasonic wave oscillator 101B is ON/OFF controlled to vibrate the butted-against portion 107B for shaping. On shaping, the ultrasonic wave oscillator 101B is controlled, as in the case of the foregoing second embodiment, in consideration of the amount of deformation of the butted-against portion 107B after the stoppage of the ultrasonic wave to deform the butted-against portion 107B into the target amount of deformation H2.

Step S142; It is determined whether or not the butted-against portion 107B has been shaped into the target amount of deformation H2. On determining, the deformation after the stoppage of the ultrasonic vibration is taken into consideration as in the case of the foregoing second embodiment. If the shaping of the butted-against portion 107B has not yet been terminated, the process proceeds to a Step S144, and if it has been terminated, the process proceeds to a Step S143.

Step S143; A termination flag 2 is set.

Step S144; It is determined whether or not the termination flags 1 and 2 have both been set, and if they have both not been set, the process returns to the Step S136, and if they have both been set, it is determined that the shaping operation has been terminated to terminate the operation. The Steps S136 to S144 were executed at every 10 msec cycle.

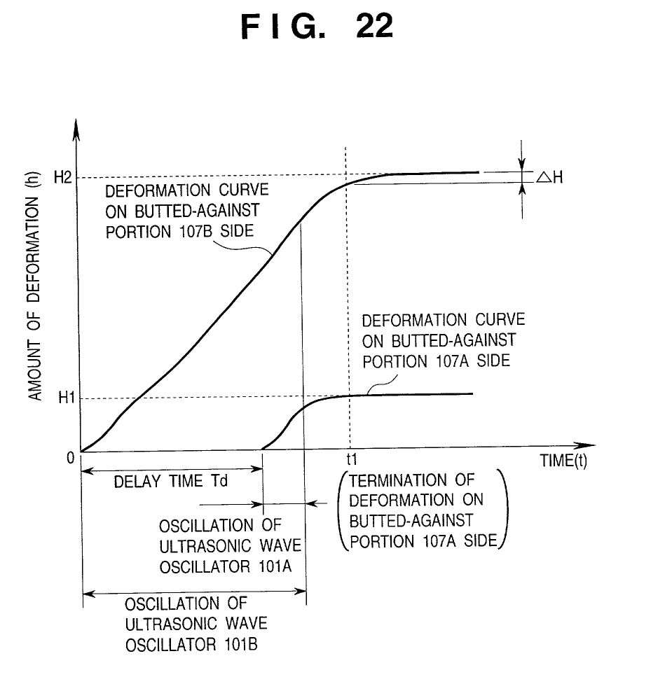

In such a shaping operation, if the target amount of deformation H1 of the butted-against portion 107A is smaller than the target amount of deformation H2 of the butted-against portion 107B, the vibration of the butted-against portions 107A and 107B will be terminated at the substantially same time as shown in FIG. 22. As a result, the problem caused by greatly shifted deformation-terminated time of the butted-against portions 107A and 107B, that is, the large lean of the contact surface of the butted-against portion 107A can be prevented.

In this respect, in the present embodiment, the description has been made of the example of shaping the butted-against portions at two places, and the similar shaping operation can be performed for butted-against portions at three or more places to terminate those deformation at the substantially same time.

As described above, in the second and third embodiments, an amount of deformation after the stoppage of vibration in the shaping area of a molded item is predicted on the basis of deformation velocity of the shaping area, and when an amount of deformation obtained by adding the predicted amount of deformation after the stoppage of vibration to an amount of deformation in the shaping area up to the present moment, reaches the target amount of deformation, the vibration of the shaping area can be terminated to thereby shape the shaping area with a high degree of precision to the target amount of deformation.

The amount of deformation of the shaping area after the stoppage of vibration can be determined using, for example, a monotone increase function f(t) of elapsed time t from the commencement of shaping using ultrasonic vibration up to the present moment, or a monotone increase function f(h) of an amount of deformation h up to the present moment.

By shifting the vibration start time for each shaping area in accordance with the target amount of deformation for each shaping area in such a manner to terminate deformation in a plurality of shaping areas at the substantially same time, it is possible to prevent large lean of a molded item during the shaping operation and to shape a plurality of shaping areas by a target amount of deformation with a higher degree of precision.

The present invention is not limited to the above embodiments and various changes and modifications can be made within the spirit and scope of the present invention. Therefore, to apprise the public of the scope of the present invention the following claims are made.

What is claimed is:

1. A positioning method for a registration portion of a molded item for positioning the registration portion of said molded item in order to improve positioning accuracy of said molded item to another member, said registration portion being positioned by heat-deforming said registration portion by ultrasonic vibration.

2. The positioning method for a registration portion of a molded item according to claim 1, wherein positioning is made by pressing said registration portion against a ultrasonic heater fixed for pressurizing.

3. The positioning method for a registration portion of a molded item according to claim 2, wherein a position of said molded item is measured in a state in which said registration portion is butted against said ultrasonic vibrator, and said registration portion is positioned on the basis of a measured position of said molded item in a state in which said butted-against portion is butted against said ultrasonic vibrator.

4. The positioning method for a registration portion of a molded item according to claim 3, wherein said registration portion is worked into desired dimensions while the position of said molded item is being measured.

5. The positioning method for a registration portion of a molded item according to claim 3, wherein the same load as in a state in which said molded item is installed to the product is applied to said registration portion for working.

6. The positioning method for a registration portion of a molded item according to claim 1, wherein said registration portion is worked at a plurality of places at the same time.

7. A positioning apparatus for a registration portion of a molded item for positioning the registration portion of said molded item in order to improve positioning accuracy of said molded item to another member, comprising:
a ultrasonic vibrator for abutting upon said registration portion to cause said registration portion to generate heat by ultrasonic vibration; and
biasing means for biasing said registration portion against said ultrasonic vibrator.

8. The positioning apparatus for a registration portion of a molded item according to claim 7, further comprising first measuring means for measuring the position of said molded item.

9. The positioning apparatus for a registration portion of a molded item according to claim 8, wherein said first measuring means is a laser distance meter.

10. The positioning apparatus for a registration portion of a molded item according to claim 7, further comprising second measuring means for measuring the position of said ultrasonic vibrator.

11. The positioning apparatus for a registration portion of a molded item according to claim 10, wherein said second measuring means is a laser distance meter.

12. The positioning apparatus for a registration portion of a molded item according to claim 7, further comprising third measuring means for measuring an amount of working for said registration portion.

13. The positioning apparatus for a registration portion of a molded item according to claim 12, wherein said third measuring means is a laser distance meter.

14. An installing method for a part for installing a second part to a first part, comprising the Steps of:
providing said first part with a positioning portion for registering with a registration portion of said second part;
providing said second part with a protruded portion for registering with a positioning portion of said first part; and
working said protruded portion by ultrasonic heating to register said first part with said second part.

15. An installing method for a part for registering a first part and a second part with a reference position for installing, comprising the steps of:
providing said first part with a positioning portion for registering with a registration portion of said second part;
providing said second part with a protruded portion for registering with a positioning portion of said first part;
measuring an amount of deviation of an installation position of said second part from said reference position;
working said protruded portion by ultrasonic heating in accordance with said measured result; and
correcting the registration portion of said second part for installing.

16. The installing method for a part according to claim 15, wherein an amount of working of said protruded portion of said second part by ultrasonic heating is measured, and the ultrasonic output is adjusted in accordance with the measured value by said measurement.

17. A shaping method for a molded item for heat-deforming a shaping area of said molded item by ultrasonic vibration to shape the shaping area by a target amount of deformation, comprising the steps of:
predicting an amount of deformation after stoppage of vibration in said shaping area on the basis of deformation velocity of said shaping area during vibration; and
terminating the vibration in said shaping area when an amount of deformation obtained by adding said predicted amount of deformation after the stoppage of vibration to an amount of deformation of said shaping area up to the present moment reaches said target amount of deformation.

18. The shaping method for a molded item according to claim 17, wherein assuming the target amount of deformation of said shaping area to be H, and the amount of deformation up to the present moment to be h, and predicting an amount of deformation hc after the stoppage of vibration in said shaping area on the assumption that it is proportionate to a deformation velocity at the present moment, the vibration in said shaping area is continued when h+hc<H, and the vibration in said shaping area is terminated when h+hc≧H.

19. The shaping method for a molded item according to claim 17, wherein assuming the present deformation velocity of said shaping area to be V, elapsed time from the commencement of shaping by ultrasonic vibration to the present moment to be t, and a monotone increase function of the time t to be f(t) respectively, an amount of deformation hc after said stoppage of vibration is determined from the following equation:
hc=V·f(t)

20. The shaping method for a molded item according to claim 17, wherein assuming the present deformation velocity of said shaping area to be V, an amount of deformation up to the present moment to be h, and a monotone increase function of the amount of deformation h to be f(h) respectively, an amount of deformation hc after said stoppage of vibration is determined from the following equation:
hc=V·f(h)

21. The shaping method for a molded item according to claim 17, wherein a plurality of said shaping areas are individually ultrasonic-vibrated to thereby shape each shaping area by the respective target amounts of deformation.

22. The shaping method for a molded item according to claim 21, wherein vibration start time for each shaping area is shifted in accordance with the target amount of deformation for each shaping area in such a manner that shaping for said plurality of shaping areas is terminated at the substantially same time.

23. The shaping method for a molded item according to claim 17, wherein said shaping area is a butted-against portion which serves as a reference position for installing said molded item.

24. A shaping apparatus for a molded item for heat-deforming a shaping area of said molded item by ultrasonic vibration to shape the shaping area by a target amount of deformation, comprising:
predicting means for predicting an amount of deformation after stoppage of vibration in said shaping area on the basis of the deformation velocity of said shaping area during vibration; and
control means for terminating the vibration in said shaping area when an amount of deformation obtained by adding said predicted amount of deformation after the stoppage of vibration to an amount of deformation of said shaping area up to the present moment reaches said target amount of deformation.

25. The shaping apparatus for a molded item according to claim 24, wherein assuming the target amount of deformation of said shaping area to be H, and the amount of deformation up to the present moment to be h, said predicting means predicts an amount of deformation hc after the stoppage of vibration in said shaping area on the assumption that it is proportionate to the deformation velocity at the present moment, and said control means continues the vibration in said shaping area when h+hc<H, and terminates the vibration in said shaping area when h+hc≧H.

26. The shaping apparatus for a molded item according to claim 24, wherein assuming the present deformation velocity of said shaping area to be V, elapsed time from the commencement of shaping by ultrasonic vibration to the present moment to be t, and a monotone increase function of the time t to be f(t) respectively, said predicting means determines an amount of deformation hc after said stoppage of vibration from the following equation:
hc=V·f(t)

27. The shaping apparatus for a molded item according to claim 24, wherein assuming the present deformation velocity of said shaping area to be V, an amount of deformation up to the present moment to be h, and a monotone increase function of the amount of deformation h to be f(h) respectively, said predicting means determines an amount of deformation hc after said stoppage of vibration from the following equation:
hc=V·f(h)

28. The shaping apparatus for a molded item according to claim 24, further comprising a plurality of ultrasonic vibrating means capable of shaping each shaping area by the respective target amounts of deformation by individually ultrasonic-vibrating a plurality of said shaping areas.

29. The shaping apparatus for a molded item according to claim 28, further comprising vibration start time setting means for shifting the vibration start time for each shaping area by said plurality of ultrasonic vibrating means in accordance with the target amount of deformation for each shaping area in such a manner that shaping for said plurality of shaping areas is terminated at the substantially same time.

30. An installing method for a part for registering a first part and a second part for installing, comprising the steps of:
providing said second part with a protruded portion at a position corresponding to at least biaxial directions of X-axis and Y-axis at the installation position of said first part;
measuring amounts of working of said protruded portion for installing said second part to the installation position of said first part respectively;
working said protruded portion by ultrasonic heating in accordance with said measured results; and
registering said first and second parts for installing.

31. The installing method for a part according to claim 30, wherein an amount of working for said protruded portion of said second part by ultrasonic heating is measured, and the ultrasonic output is adjusted in accordance with measured values of said measurement.
